(19) United States
(12) Patent Application Publication
(10) Pub. No.: US 2005/0265491 A9
(43) Pub. Date: Dec. 1, 2005

(54) Add-compare-select-offset device and method in a decoder

(76) Inventors: Pascal Urard, Theys (FR); Laurent Paumier, Grenoble (FR); Etienne Lantreibecq, Challes Les Eaux (FR)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/841,395

(22) Filed: May 7, 2004

(30) Foreign Application Priority Data
May 9, 2003 (FR) 03/05648

(51) Int. Cl. H04L 5/12

(52) U.S. Cl. 375/341

(57) ABSTRACT

An add-compare-select-offset device including first and second adders for generating values a and b respectively equal to the sum of first previous state and branch metrics and to the sum of second previous state and branch metrics, a calculation block for providing the greatest of values a and b on a first output and generating an adjustment value on a second output; and, a third adder for generating a current state metric equal to the sum of the outputs of the calculation block, wherein the adders perform additions without keeping the carry so that the current state metric and intermediary values a and b comprise the same number of bits as the first and second previous state metrics.

### BACKGROUND OF THE INVENTION

1. Field of the Invention

The present invention generally relates to signal decoders, like for example decoders of turbodecoder type. More specifically, the present invention relates to units used in such decoders, generally called ACSO (“Add-Compare-Select-Offset”) units, which perform additions to provide a plurality of data, then comparisons of the obtained data and a selection of one among the obtained data and offsets of the selected datum.

2. Discussion of the Related Art

One the aims of digital communications is faultless data transmission. During transmission, the data are submitted to noise, which may cause errors on the received data. To improve the reliability upon data transmission, error-correction techniques are used. A known error correction technique is the convolution coding. This technique provides an efficient error correction but requires sophisticated decoding techniques.

Error correction codes have a significant technical effect since they enable error correction on data transmitted between a transmitter and a receiver in applications such as telecommunications.

Convolution codes enable the digital data receiver to properly determine the transmitted data even when errors have occurred during transmission. Convolution codes introduce redundancies in the data to be transmitted and sequentially provide the transmitted data in packets in which the value of each bit depends on previous bits in the sequence. Thus, when errors occur, the receiver can deduce the original data by retracing the possible sequences of received data.

To improve the coding efficiency, coding methods comprise interleavers, which mix the bit order of the coded packet. Thus, when adjacent bits are altered during transmission, the error is distributed over the entire initial packet and can thus be more efficiently corrected.

Other improvements may comprise coders which code the data to be transmitted more than once, in parallel or in series. For example, error correction methods are known which transmit coded data packets for which each packet is formed by the juxta-position of initial uncoded data, of first coded data resulting from a coding of the initial data by a first coder, and of second coded data resulting from a coding of the initial data by a second coder preceded by an interleaver. Such an error correction method is called a systematic parallel convolutional coding (SPCC). Each transmitted data packet may correspond to a single bit of the initial data, and the coding is then said to be in monobinary mode; or correspond to a couple of bits (or “bibit”) of the initial data, and the coding is then said to be in duobinary mode.

It is known to decode by “turbodecoding” data coded in monobinary mode with an iterative algorithm, relatively efficient to achieve low error rates. Rather than immediately determining whether the received data are equal to “0” or to “1”, the receiver assigns to each received datum a value on a scale with several levels representing the probability for the datum to be equal to “1”. A conventional scale, usually called the log likelihood ratio LLR, represents each decoded datum x with an integer coded over a predetermined number of bits. For a received datum r, ratio LLR is determined as follows:

$$LLR ( x ) = log ( \frac{Pr ( x = 1 / r )}{Pr ( x = 0 / r )} ) \qquad ( 1 )$$

where Pr(x=1/r) represents the probability for decoded datum x to be equal to “1” for the received datum r and Pr(x=0/r) represents the probability for decoded datum x to be equal to “0” for the received datum r.

The iterative decoding method receives an input sequence corresponding to probabilities for each received value and outputs corrected probabilities. The iterative decoding is performed by several iterations after which the corrected probability sufficiently closely represents the transmitted datum.

The value of ratio LLR is then compared with a threshold to determine the value of decoded datum x. For example, the decoded datum is taken to be equal to “1” when ratio LLR is positive and to “0” otherwise. Ratio LLR thus contains both information representative of the value of decoded datum x and information representative of the reliability of the value of the decoded datum.

The calculation algorithm of ratio LLR is based on a lattice similar to that used in the Viterbi algorithm.

FIG. 1 shows an example of a lattice with N states, N being equal to 4 in FIG. 1. Four states Sᵢ, i ranging from 1 to 4, are represented along the vertical direction. Different times k, k ranging from 1 to 5, are shown along the horizontal direction. Each point S_{i,k} of the lattice represents the i^{th} state at time k. A state may represent a sequence of a determined number of bits corresponding to the supposed state of several flip-flops of the convolution coder upon transmission. For a four-state lattice, each state may be associated with one of the sequences (“00”, “01”, “10”, “11”) corresponding to the supposed state of two flip-flops of the coder. A branch B represents a transition between a state at a time k and a state at a time k+1. The transition from one state to another corresponds to the reception by the decoder of a datum corresponding to a bit of value “0” or “1”. From a state at a time k, for example, state S_{2,3}, there thus are but two possible transitions to states S_{3,4} and S_{4,4} according to whether the received datum is a bit of value “0” or “1”.

In practice, datum rₖ received at a time k is an analog datum. For a lattice branch connecting state S_{i,k} to state S_{m,k+1}, a metric γₖ of the branch corresponding to a possible transition from state S_{i,k} to state S_{m,k+1} is determined. The branch metric corresponds to a distance between received datum rₖ and datum xₖ(S_{i,k}, S_{m,k+1}) which should have been received for the branch. It may be calculated as follows:

$${γ}_{k} ( {S}_{i , k} , {S}_{m , k + 1} ) = exp [ - \frac{1}{2 {σ}^{2}} {‖ {r}_{k} - {x}_{k} ( {S}_{i , k} , {S}_{m , k + 1} ) ‖}^{2} ] \qquad ( 2 )$$

where σ² is the noise variance associated with received datum rₖ and γₖ(S_{i,k},S_{m,k+1})=0 if there is no branch between states S_{i,k} and S_{m,k}. Two categories of branch metrics can be distinguished hereafter:
γₖ²(S_{i,k},S_{m,k+1}), equal to γₖ(S_{i,k},S_{m,k+1}) if the transition from state S_{i,k} to state S_{m,k+1} corresponds to an information bit at the coder input equal to 1, and equal to 0 otherwise; and
γk⁰(S_{i,k},S_{m,k+1}), equal to γₖ(S_{i,k},S_{m,k+1}) if the transition from state S_{i,k} to state S_{m,k+1} corresponds to an information bit at the coder input equal to 0, and equal to 1 otherwise.

The calculation algorithm of ratio LLR comprises three main steps.

At a time k, a forward probability αₖ(S_{i,k}) of being at state S_{i,k} is calculated for each state S_{i,k}, i ranging from 1 to N, as follows:

$${α}_{k} ( {S}_{i , k} ) = {\sum }_{ℓ = 1}^{N} {\sum }_{j = 0}^{1} {α}_{k - 1} ( {S}_{ℓ , k - 1} ) {γ}_{k}^{j} ( {S}_{ℓ , k - 1} , {S}_{i , k} ) \qquad ( 3 )$$

For each state S_{i,k}, with i ranging from 1 to N, a backward probability βₖ(S_{i,k}) of being at state S_{i,k} is also calculated at time k by the following equation:

$${β}_{k} ( {S}_{i , k} ) = {\sum }_{ℓ = 1}^{N} {\sum }_{j = 0}^{1} {β}_{k + 1} ( {S}_{ℓ , k + 1} ) {γ}_{k + 1}^{j} ( {S}_{i , k} , {S}_{ℓ , k + 1} ) \qquad ( 4 )$$

From these two probabilities, ratio LLR is calculated as follows:

$$LLR ( {x}_{k} ) = log \frac{{\sum }_{( i , ℓ ) ∈ B ( k , 1 )} {α}_{k - 1} ( {S}_{ℓ , k - 1} ) {γ}_{k}^{1} ( {S}_{ℓ , k - 1} , {S}_{i , k} ) {β}_{k} ( {S}_{i , k} )}{{\sum }_{( i , ℓ ) ∈ B ( k , 0 )} {α}_{k - 1} ( {S}_{ℓ , k - 1} ) {γ}_{k}^{0} ( {S}_{ℓ , k - 1} , {S}_{i , k} ) {β}_{k} ( {S}_{i , k} )} \qquad ( 5 )$$

where B(k,0) (respectively B(k,1)) is the set of possible transitions from a state S_{1,k-1} to a state _{Si,k} caused by an input datum equal to “0” (respectively, “1”).

The calculation of ratio LLR requires calculating multiplications and exponential values. Such operations are difficult to implement. For this purpose, the following function is introduced:
MAX⁺(x, y)=ln(e^{x}+e^{y})=MAX(x, y)+ln(1+e^{=|x-y|)} (6)
where term ln(1+e^{-|x-y|}) is an offset value. The offset value may be obtained by means of a memory, for example, a ROM, in which are memorized values of function ln(1+e^{|v|}) over a determined number of bits for certain values |v|coded over a determined number of bits. As a result:

$$\begin{matrix}ln ( {\sum }_{i = 0}^{N} {ⅇ}^{{x}_{i}} ) = {MAX}^{+} ( ln ( {\sum }_{i = 0}^{N - 1} {ⅇ}^{{x}_{i}} ) , {x}_{i} ) \\ = {MAX}^{+} ( {MAX}^{+} ( ln ( {\sum }_{i = 0}^{N - 2} {ⅇ}^{{x}_{i}} ) , {x}_{N - 1} ) , {x}_{N} ) \\ = … = {{MAX}_{i ∈ [ 1 , N ]}}^{+} ( {x}_{i} )\end{matrix} \qquad ( 7 )$$

The following definitions are thus introduced:
γₖ⁻¹(S_{m,n},S_{i,k})=log(γₖ¹(S_{m,n},S_{i,k}))
γₖ⁻⁰(S_{m,n},S_{i,k})=log(γₖ⁰(S_{m,n},S_{i,k})) (8)
\overline{α}ₖ(S_{i,k})=log αₖ(S_{i,k}) (9)

Term \overline{α}ₖ(S_{i,k}) is called the forward state metric for state S_{i,k} or forward path metric for state S_{i,k}.
\overline{β}ₖ(S_{i,k})=log(βₖ(S_{i,k})) (10)

Term \overline{β}ₖ(S_{i,k}) is called the backward state metric for state S_{i,k} or backward path metric for state S_{i,k}.

As a result:

$$\begin{matrix}{\overline{α}}_{k} ( {S}_{i , k} ) = {{MAX}_{( i , m ) ∈ B ( k , j )}}^{+} ( {\overline{α}}_{k - 1} ( {S}_{m , k - 1} ) + {γ}_{k}^{- j} ( {S}_{m , k - 1} , {S}_{i , k} ) ) & ( 11 ) \\ {\overline{β}}_{k - 1} ( {S}_{i , k - 1} ) = {{MAX}_{( m , i ) ∈ B ( k , j )}}^{+} ( {\overline{β}}_{k} ( {S}_{m , k} ) + {γ}_{k}^{- j} ( {S}_{i , k - 1} , {S}_{m , k} ) ) & ( 12 )\end{matrix}$$

The expression of ratio LLR becomes:

$$\begin{matrix}LLR ( {x}_{k} ) = {{MAX}_{( i , m ) ∈ B ( k , 1 )}}^{+} ( {\overline{α}}_{k - 1} ( {S}_{m , k - 1} ) + {γ}_{k}^{- 1} ( {S}_{m , k - 1} , {S}_{i , k} ) + {\overline{β}}_{k} ( {S}_{i , k} ) ) - \\ {{MAX}_{( i , m ) ∈ B ( k , 0 )}}^{+} ( {\overline{α}}_{k - 1} ( {S}_{m , k - 1} ) + {γ}_{k}^{- 0} ( {S}_{m , k - 1} , {S}_{i , k} ) + {\overline{β}}_{k} ( {S}_{i , k} ) )\end{matrix} \qquad ( 13 )$$

The calculations of forward metric \overline{α}ₖ(S_{i,k}) and backward metric \overline{β}ₖ(S_{i,k}) are performed by specific units of the decoder called ACSO (“ADD-COMPARE-SELECT-OFFSET) units that implement function MAX⁺.

The iterative operation of an ACSO unit implies forming several accumulations of a large number of sums of state and branch metrics within a time period smaller than the period separating the reception of two successive bits. Such an operating speed generally implies using redundant means in ACSO units, which makes the structure of these units more complex. Further, to limit the size of the adders used for accumulations without risking an information loss due to a saturation of the adders, the ACSO units comprise limiting means to, for example, when one of the accumulations exceeds a predetermined threshold, dividing all the accumulations by a predetermined value. Such means for limiting the accumulations also make the structure of ACSO units complex. ACSO units may also comprise means enabling compensation of a variation of the branch metric due to a variation in the transmission gain. Such gain compensation means have in particular the effect of increasing the size of the ROM in which are memorized the adjustment values, and make even more complex the preceding accumulation limiting means.

A coding in duobinary mode enables transmitting at an equal frequency the data with a greater rate than a coding in monobinary mode. No simple devices are however known to implement a decoding in duobinary mode.

### SUMMARY OF THE INVENTION

An object of the present invention consists of providing a simple and low-cost device to implement a decoding in monobinary mode.

Another object of the present invention consists of providing a simple and low-cost device to implement a decoding in duobinary mode.

To achieve these and other objects, the present invention provides a device for implementing a function of add-compare-select-offset type in an error-correction code decoder, comprising:
first and second adders for generating first and second intermediary metric values a and b respectively equal to the sum of a first previous state metric and of an associated branch metric and to the sum of a second previous state metric and of an associated branch metric;
a calculation block receiving values a and b, to compare values a and b, select the greatest of values a and b and provide said selected value on a first output, and to generate on a second output an adjustment value corresponding to an approximation of ln(1+e^{-|a-b|}); and
a third adder for generating a current state metric equal to the sum of the outputs of the calculation block;
wherein the first and second previous state metrics are coded over a same number of bits, and wherein the adders perform additions without keeping the carry so that the current state metric and intermediary values a and b comprise the same number of bits as the first and second previous state metrics.

The present invention also aims at a device for implementing a function of add-compare-select-offset type in an error-correction code decoder operating in duobinary mode, comprising:
first and second devices such as described hereabove respectively comprising first and second calculation blocks for generating first and second current state metrics respectively from first and second previous state metrics and first and second associated branch metrics and from third and fourth previous state metrics and third and fourth associated branch metrics;
a third calculation block such as described hereabove receiving as an input the first and second current state metrics; and
an adder for generating a third current state metric equal to the sum of the outputs of the third calculation block, in which the previous state metrics are each coded over a same number of bits, said adder performing additions without keeping the carry so that the third current state metric comprises the same number of bits as the previous state metrics.

According to an embodiment of the present invention, the calculation block comprises a subtractor for calculating the difference of the first and second values received by the calculation block, a multiplexer controlled by the output of the subtractor to generate on the first output of the calculation block the largest of the received values, and an approximation block for generating on the second output of the calculation block the adjustment value in the form of a value of one bit equal to 1 if said difference is equal to 0, 1, or −1, and equal to 0 otherwise.

According to an embodiment of the present invention, the approximation block comprises a first logic gate calculating a NOR of all the bits of said difference except for its least significant bit, a second logic gate calculating an AND of all the bits of said difference, and a third logic gate calculating an OR of the outputs of the first and second logic gates.

The present invention also aims at a decoder comprising 2^{N}, where N is greater than 1, devices in duobinary mode such as described hereabove, each of which is associated with a specific N bit value, the decoder receiving data in the form of consecutive bibits;
the output of each device associated with a first value being connected to provide one of the previous state metrics to four devices, each associated with a value, the N−2 most significant bits of which are the N−2 least significant bits of said first value and the two least significant bits of which respectively are one of the four possible values of the last received bibit;
each device associated with a first value, the two least significant bits of which are one of the four possible values (00, 01, 10, 11) of a bibit receiving as branch metrics a value corresponding to a distance between the received bibit and said one of the four possible values of a bibit.

The present invention also aims at a method for implementing a function of add-compare-select-offset type in an error-correction code decoder operating in monobinary mode, comprising the steps of:
i/ generating first and second intermediary metrics values, a and b, respectively equal to the sum of a first previous state metric and of an associated branch metric and to the sum of a second previous state metric and of an associated branch metric;
ii/ comparing values a and b, selecting the largest of values a and b, and providing said selected value on a first output, and generating on a second output an adjustment value corresponding to an approximation of ln(1+e^{-|a-b|}); and
iii/ generating a current state metric equal to the sum of the outputs of the calculation block;
the first and second previous state metrics being coded over a same number of bits and the sums calculated at steps i/ and iii/ being performed without keeping the carry, so that the current state metric and intermediary values a and b comprise the same number of bits as the first and second previous state metrics.

The present invention also aims at a method for implementing a function of add-compare-select-offset type in an error-correction code decoder operating in duobinary mode, comprising the steps of:
iv/ generating first and second current state metric according to the previously-described method in monobinary mode, respectively from first and second previous state metrics and from first and second associated branch metrics and from third and fourth previous state metrics and from third and fourth associated branch metrics;
v/ providing a selected value and an approximation value calculated according to step ii/ of the previously-described method in monobinary mode, based on the first and second current state metric; and
vi/ generating a third current state metrics equal to the sum of the values generated at step v/, the previous state metric being each coded over a same number of bits and said sum being calculated without keeping the carry so that the third current state metric comprises the same number of bits as the previous state metrics.

According to an embodiment of the present invention, at step ii/, the value is selected by calculating the difference of the compared values and by providing the largest of the compared values based on the sign of said difference, and the adjustment value is generated as being a value of one bit equal to 1 if said difference is equal to 0, 1, or −1, and equal to 0 otherwise.

According to an embodiment of the present invention, the adjustment value is equal to the logic OR of a logic NOR of all the bits of said difference except for its least significant bit and of a logic AND of all the bits of said difference.

The present invention also aims at a method for decoding in a lattice comprising 2^{N}, where N is greater than 1, states each associated with a specific N-bit value, data received in the form of consecutive bibits, comprising the steps of:
vii/ for the first received bibit, generating according to the previously-described decoding method in duobinary mode 2^{N} current state metrics each associated with one of said values based on four predetermined initial previous state metrics and based on four identical branch metric corresponding to a distance between the received bibit and a value of the bibit equal to the two least significant bits of said one of said values;
viii/ for each subsequently received bibit, generating according to the previously-described decoding method in duobinary mode 2^{N} current state metric each associated with one of said values, taking for the four previous state metrics the four current state metrics generated for the previous received bibit and associated with a value, the N−2 least significant bits of which are the N−2 most significant bits of said one of said values, and taking for the four branch metrics a distance between the received bibit and a value of the bibit equal to the two least significant bits of said one of said values.

The foregoing objects, features, and advantages of the present invention will be discussed in detail in the following non-limiting description of specific embodiments in connection with the accompanying drawings.

### BRIEF DESCRIPTION OF THE DRAWINGS

FIG. 1, previously described, shows an example of a lattice used for a monobinary decoding;

FIG. 2 shows an example of a lattice used for a duobinary decoding according to the present invention;

FIG. 3 shows an embodiment of an ACSO unit according to the present invention; and

FIG. 4 shows an example of a decoding circuit corresponding to the lattice of FIG. 2 using ACSO units such as in FIG. 3.

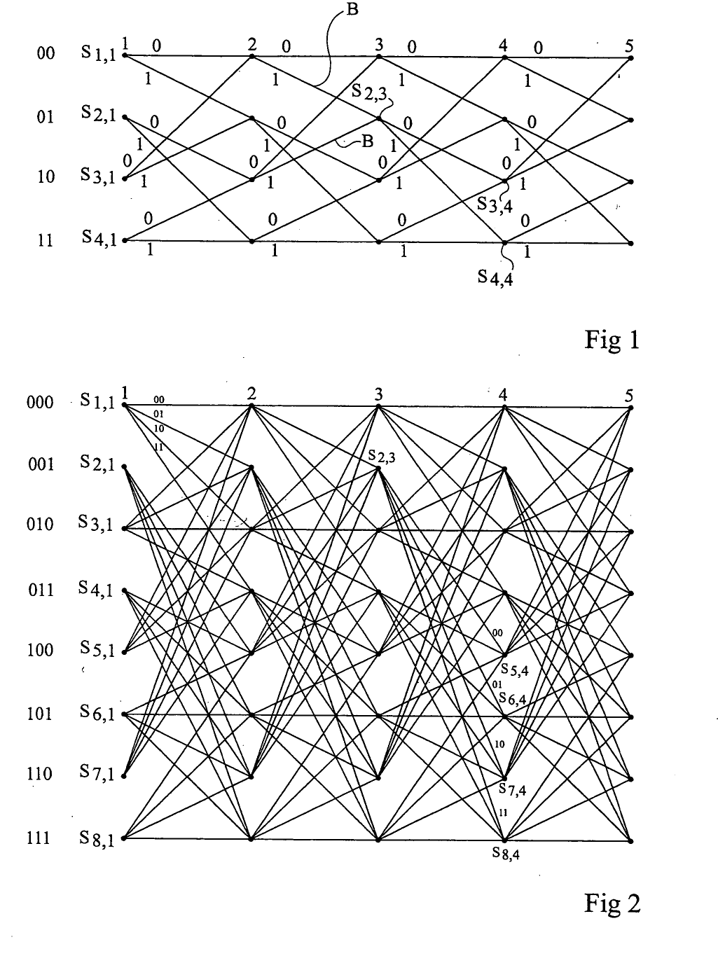

### DETAILED DESCRIPTION

FIG. 2 shows an example of a lattice for decoding data coded in duobinary mode. The lattice comprises 5 columns, each comprising 8 states S_{i,j}, where i=1-8 and j=1-5. Each column is associated with a different time corresponding to the reception of a new data bibit. For an eight-state lattice, each state may be associated with one of the sequences (“000”, “001”, “010”, “011”, “100”, “101”, “110”, “111”) of the internal states of the convolution coder. From each state at a time k (for example, state S_{2,3}), there are four possible transitions (in the considered example towards states S_{5,4}, S_{6,4}, S_{7,4}, and S_{8,4,} according to whether the received bibit has a value “00”, “01”, “10”, or “11”).

In practice, like for a decoding in monobinary mode, a transmitted bibit is received at each time k in the form of an analog datum, and with each branch of the lattice is associated a branch metric γₖ calculated substantially in the same way as according to the preceding equation (2), calling rₖ the received analog value and xₖ the bibit which should have been received for the branch, or “received bibit”.

Four categories of branch metrics are distinguished hereafter:
γₖ⁰⁰(S_{i,k},S_{m,k+1}), equal to γₖ(S_{i,k},S_{m,k+1}) if the transition from state S_{i,k} to state S_{m,k+1} corresponds to an information bibit at the coder input equal to 00, and equal to 0 otherwise;
γₖ⁰¹(S_{i,k},S_{m,k+1}), equal to γₖ(S_{i,k},S_{m,k+1}) if the transition from state S_{i,k} to state S_{m,k+1} corresponds to an information bibit at the coder input equal to 01, and equal to 1 otherwise;
γₖ¹⁰(S_{i,k},S_{m,k+1}), equal to γₖ(S_{i,k},S_{m,k+1}) if the transition from state S_{i,k} to state S_{m,k+1} corresponds to an information bibit at the coder input equal to 10, and equal to 0 otherwise;
γₖ¹¹(S_{i,k},S_{m,k+1}), equal to γₖ(S_{i,k},S_{m,k+1}) if the transition from state S_{i,k} to state S_{m,k+1} corresponds to an information bibit at the coder input equal to 11, and equal to 1 otherwise.

The present inventors have shown that it is possible, for example, by following a lattice such as in FIG. 2, to measure at each time the probability for the received bibit to have one of the four possible values, by means of four ratios LLR each calculated as follows:

$$\begin{matrix}{LLR}_{00} ( {x}_{k} ) = {{MAX}_{( i , m ) ∈ B ( k , 00 )}}^{+} ( {\overline{α}}_{k - 1} ( {S}_{m , k - 1} ) + {γ}_{k}^{- 00} ( {S}_{m , k - 1} , {S}_{i , k} ) + {\overline{β}}_{k} ( {S}_{i , k} ) ) \\ {LLR}_{01} ( {x}_{k} ) = {{MAX}_{( i , m ) ∈ B ( k , 01 )}}^{+} ( {\overline{α}}_{k - 1} ( {S}_{m , k - 1} ) + {γ}_{k}^{- 01} ( {S}_{m , k - 1} , {S}_{i , k} ) + {\overline{β}}_{k} ( {S}_{i , k} ) ) \\ {LLR}_{10} ( {x}_{k} ) = {{MAX}_{( i , m ) ∈ B ( k , 10 )}}^{+} ( {\overline{α}}_{k - 1} ( {S}_{m , k - 1} ) + {γ}_{k}^{- 10} ( {S}_{m , k - 1} , {S}_{i , k} ) + {\overline{β}}_{k} ( {S}_{i , k} ) ) \\ {LLR}_{11} ( {x}_{k} ) = {{MAX}_{( i , m ) ∈ B ( k , 11 )}}^{+} ( {\overline{α}}_{k - 1} ( {S}_{m , k - 1} ) + {γ}_{k}^{- 11} ( {S}_{m , k - 1} , {S}_{i , k} ) + {\overline{β}}_{k} ( {S}_{i , k} ) )\end{matrix} \qquad ( 14 )$$

where B(k,00) (respectively B(k,01), B(k,10), B(k,11)) is the set of all possible transitions from a state S_{m,k-1} to a state S_{i,k} caused by an input bibit equal to “00” (respectively “01”, “10”, “11”).

The decoding is performed by comparing the calculated LLRs:
if MAX(LLR₀₀(xₖ), LLR₀₁(xₖ), LLR₁₀(xₖ), LLR₁₁(xₖ))=LLR₀₀(xₖ), the decoded bibit is 00;
if MAX(LLR₀₀(xₖ), LLR₀₁(xₖ), LLR₁₀(xₖ), LLR₁₁(xₖ))=LLR₀₁(xₖ), the decoded bibit is 01;
if MAX(LLR₀₀(xₖ), LLR₀₁(xₖ), LLR₁₀(xₖ), LLR₁₁(xₖ))=LLR₁₀(xₖ), the decoded bibit is 10;
if MAX(LLR₀₀(xₖ), LLR₀₁(xₖ), LLR₁₀(xₖ), LLR₁₁(xₖ))=LLR₁₁(xₖ), the decoded bibit is 11.

Values \overline{α}ₖ₋₁, \overline{β}ₖ are respectively calculated according to previous equations (9) and (10), with αₖ(S_{i,k}), which is the forward probability of being at state S_{i,k,} equal to:

$${α}_{k} ( {S}_{i , k} ) = {\sum }_{ℓ = 1}^{N} {\sum }_{j = 00 , 01 , 10 , 11}^{3} {α}_{k - 1} ( {S}_{ℓ , k - 1} ) {γ}_{k}^{j} ( {S}_{ℓ , k - 1} , {S}_{i , k} ) \qquad ( 15 )$$

and βₖ(S_{i,k}), which is the backward probability of being at state S_{i,k,} equal to:

$${β}_{k} ( {S}_{i , k} ) = {\sum }_{l = 1}^{N} {\sum }_{j = 00 , 01 , 10 , 11}^{3} {β}_{k + 1} ( {S}_{l , k + 1} ) {γ}_{k + 1}^{j} ( {S}_{i , k} , {S}_{l , k + 1} ) \qquad ( 16 )$$

The present inventors have in particular shown that:

$$\begin{matrix}{\overline{α}}_{k} ( {S}_{i , k} ) = {MAX}^{+} ( {MAX}^{+} ( {\overline{α}}_{k - 1} ( {S}_{m1 , k - 1} ) + {γ}_{k}^{- 00} ( {S}_{m1 , k - 1} , {S}_{i , k} ) , & ( 17 ) \\ ( {\overline{α}}_{k - 1} ( {S}_{m2 , k - 1} ) + {γ}_{k}^{- 01} ( {S}_{m2 , k - 1} , {S}_{i , k} ) ) , & \\ {MAX}^{+} ( {\overline{α}}_{k - 1} ( {S}_{m3 , k - 1} ) + {γ}_{k}^{- 10} ( {S}_{m3 , k - 1} , {S}_{i , k} ) , & \\ ( {\overline{α}}_{k - 1} ( {S}_{m4 , k - 1} ) + {γ}_{k}^{- 11} ( {S}_{m4 , k - 1} , {S}_{i , k} ) ) ) & \\ and that \text{:} & \\ {\overline{β}}_{k} ( {S}_{i , k - 1} ) = {MAX}^{+} ( {MAX}^{+} ( {\overline{β}}_{k} ( {S}_{m1 , k} ) + {γ}_{k}^{- 00} ( {S}_{i , k - 1} , {S}_{m1 , k} ) , & ( 18 ) \\ ( {\overline{β}}_{k} ( {S}_{m2 , k} ) + {γ}_{k}^{- 01} ( {S}_{i , k - 1} , {S}_{m2 , k} ) ) , & \\ {MAX}^{+} ( {\overline{β}}_{k} ( {S}_{m3 , k} ) + {γ}_{k}^{- 10} ( {S}_{i , k - 1} , {S}_{m3 , k} ) , & \\ ( {\overline{β}}_{k} ( {S}_{m4 , k} ) + {γ}_{k}^{- 11} ( {S}_{i , k - 1} , {S}_{m4 , k} ) ) ) & \end{matrix}$$

with Sm1, Sm2, Sm3, Sm4 being the states preceding state Si (in the case of the calculation of α, and following state Si in the case of the calculation of β) for transitions respectively due to input bibits 00, 01, 10, and 11.

Above formulas (17) and (18) result in that each of forward and backward state metrics \overline{α}ₖ(S_{i,k}) and \overline{β}ₖ(S_{i,k}) can be calculated by an ACSO unit in duobinary mode according to the present invention, comprising two ACSO units in monobinary mode, each calculating the MAX⁺ of two sums of a state metric and of an associated branch metric, followed by a block calculating the MAX⁺ of the results of the ACSO units in monobinary mode.

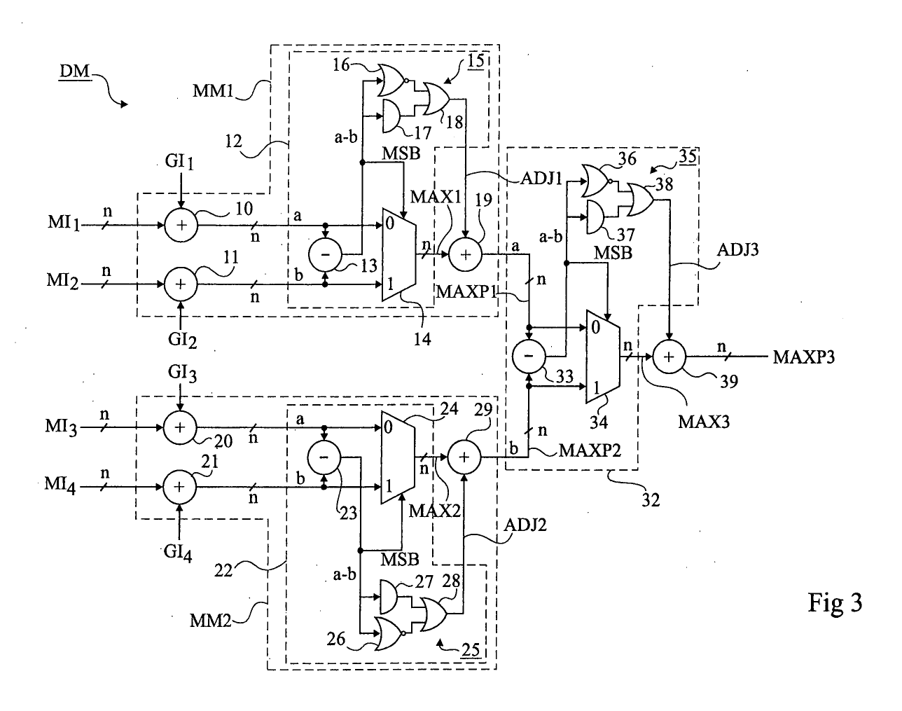

FIG. 3 shows an ACSO unit in duobinary mode MM1 according to the present invention, enabling calculation of the state metric (forward and backward) of a considered state at a given time k. Hereafter, term “state metric” is indifferently used for a forward state metric and for a backward state metric and, when reference is made to a state adjacent to the considered state, this means a state at a time subsequent k+1 or prior k−1 to the considered state, according to the considered metric.

The ACSO unit in duobinary mode DM comprises a first ACSO unit in monobinary mode MM1. Unit MM1 receives as an input data MI₁, MI₂, which respectively represent the first and second previous state metrics. Unit MM1 also receives data GI₁, GI₂, which represent branch metrics corresponding to the branches between the considered state and, respectively, the first and second adjacent states. Unit MM1 comprises two adders 10 and 11 respectively receiving as an input data MI₁, GI₁, and MI₂, GI₂. A calculation block 12 receives, on two inputs, values (a,b) output by adders 10 and 11. Calculation block 12 comprises a subtractor 13 calculating difference a−b. A multiplexer 14 receiving values a and b provides MAX1=MAX(a,b), that is, either value a or value b according to whether difference a−b is positive or negative (according to whether the sign bit of a−b is equal to 0 or 1). An approximation block 15 receives difference a−b and provides a value ADJ1 equal to 1 if difference a−b has a value equal to 0, 1, or −1, and a value equal to 0 otherwise. Value ADJ1 is shown to be an approximation coded over 1 bit of adjustment value ln(1+e^{-|a-b|}). Block 15 for example comprises a logic gate 16 calculating a NOR of all the bits of difference a−b except for its least significant bit, a logic gate 17 calculating an AND of all the bits of difference a−b, and a logic gate 18 calculating an OR of the outputs of gates 16 and 17. An adder 19 provides sum MAXP1 of values MAX1 and ADJ1, where MAXP1=MAX⁺(a,b) in compliance with formula (6).

Duobinary ACSO unit DM comprises a second monobinary ACSO unit MM2 of same structure as unit MM1, generating a current state metric MAXP2 based on data MI₃, MI₄, GI₃, and GI₄ respectively representing the third and fourth previous state metrics and corresponding branch metrics. Same reference numerals in which the 1 of the ten's place has been replaced with a 2 refer to same elements in units MM1 and MM2.

Duobinary ACSO unit DM also comprises a calculation block 32 of same structure as calculation block 12 of unit MM1. Same reference numerals in which the 1 of the tens has been replaced with a 3 refer to same elements in blocks 12 and 32. Block 32 receives outputs MAXP1 and MAXP2 of units MM1 and MM2 and provides an adder 39 with a value MAX3 equal to the maximum of MAXP1 and MAXP2 and an adjustment value ADJ3 corresponding to ln(1+e^{-|MAXP1-MAXP2|}). Output MAXP3 of adder 39 forms the output of unit DM. Unit DM operates preferably synchronously, and comprises data synchronization means not shown such as D flip-flops. Unit DM also preferably comprises reset means not shown, for example, enabling controllably setting back to 0 the outputs of adders 10 and 11 of unit MM1 and the corresponding adders of unit MM2.

The present inventors have shown that the performances of a decoder using a monobinary ACSO unit according to the present invention such as unit MM1, with a single-bit adjustment value ADJ1, are not under the performances of a decoder using a conventional monobinary ACSO unit with an adjustment value over several bits stored in a ROM. Indeed, a decoder comprises other systems (in particular upstream of the LLR calculation), the operation of which is more penalizing for the decoder performances, so that the use of a single-bit adjustment value has no influence on the general decoder performances. It can also be shown that a decoder using a DM unit with single-bit adjustment values ADJ1, ADJ2, and ADJ3 according to the present invention has performances which are as good as those of a decoder using a unit DM with adjustment values over several bits generated by means of ROMs, while having a size substantially reduced by the suppression of the ROMs.

State metric values MI₁, MI₂ are coded over a same number of bits n. According to the present invention and in particularly advantageous fashion, adders 10, 11, and 19 of unit MM1 operate modulo n without keeping the carry, to each provide an output coded over the same number of bits n. The present inventors have indeed found that upon implementation of above formulas (17) or (18), the maximum difference between sum a of MI₁ and GI₁ and sum b of MI₂ and GI₂ is always smaller than a predetermined value δ, as well as a+ADJ1−b or b+ADJ1−a. If n is chosen such that n≧2δ, the fact for the adders of unit MM1 to perform additions modulo n introduces no error in the calculation of the output value of unit MM1. Similarly, the values of state metrics MI₃, MI₄ are coded over n bits and the adders of unit MM2 as well as adder 39 operate with no keeping of the carry, whereby the value output by unit MM1 is also coded over n bits. Such an ACSO unit structure has the advantage of never being saturated while being particularly simple to implement. Further, such a structure advantageously comprises a single gain compensation means (not shown) on its input, and not a plurality of such means arranged at the level of the adders performing the accumulations in conventional ACSO units.

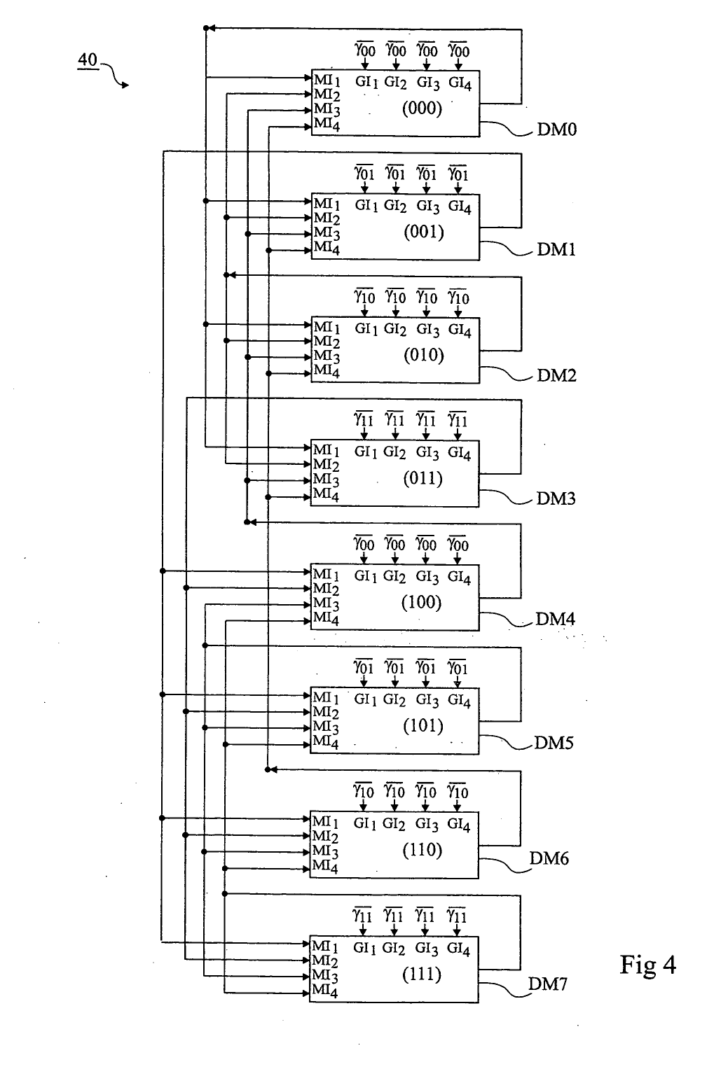

FIG. 4 schematically shows an example of a circuit 40 using ACSO units in duobinary mode according to the present invention to perform a decoding based on the lattice of FIG. 2. Circuit 40 comprises eight ACSO units (DM0, DM1, DM2, DM3, DM4, DM5, DM6, DM7). The four state metric inputs MI₁, MI₂, MI₃, MI₄ of units DM0, DM1, DM2, and DM3 are respectively connected to the outputs of units DM0, DM2, DM4, and DM6. The four state metric inputs MI₁, MI₂, MI₃, MI4 of units DM4, DM5, DM6, and DM7 are respectively connected to the outputs of units DM1, DM3, DM5 and DM7. Units DM0, DM1, DM2, DM3, DM4, DM5, DM6, DM7 are rated by a signal not shown to provide an output value upon reception of each bit.

The four branch metric inputs GI₁, GI₂, GI₃, GI₄ of units DM0 and DM4 are connected to a block not shown providing upon reception of each bibit a branch metric \overline{γ}₀₀ corresponding to the distance between value 00 and the value of the received bibit. Similarly, the branch metric inputs of the units, respectively DM1 and DM5, DM2 and DM6, DM3 and DM7 receive upon reception of each bibit values \overline{γ}₀₁, \overline{γ}₁₀, \overline{γ}₁₁ corresponding to the distances between values 01, 10, 11 and the value of the received bibit.

Of course, the present invention is likely to have various alterations, modifications, and improvements which will readily occur to those skilled in the art. In particular, each of the described components may be replaced with one or several components performing the same function. Thus, the structures of unit MM1, of calculation block 12, or of block 15 may be similar to the corresponding structures described in European patent application number 03354009.7 filed by the applicant.

The present invention has been described in relation with a decoding according to an 8-state lattice such as in FIG. 2, but those skilled in the art will readily adapt the present invention to a decoding according to other 8-state lattices or according to a 2^{N}-state lattice, where N is greater than 1.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A device (MM1) for implementing a function of add-compare-select-offset type in an error-correction code decoder, comprising:
first and second adders for generating first and second intermediary metric values a and b respectively equal to the sum of a first previous state metric and of an associated branch metric and to the sum of a second previous state metric and of an associated branch metric;
a calculation block receiving values a and b, to compare values a and b, select the greatest of values a and b and provide said selected value on a first output, and to generate on a second output an adjustment value corresponding to an approximation of ln(1+e^{-|a-b|}); and
a third adder for generating a current state metric equal to the sum of the outputs of the calculation block;
wherein the first and second previous state metrics are coded over a same number of bits, and wherein the adders perform additions without keeping the carry so that the current state metric and intermediary values a and b comprise the same number of bits as the first and second previous state metrics.

2. A device for implementing a function of add-compare-select-offset type in an error-correction code decoder operating in duobinary mode, comprising:
first and second devices of claim 1 respectively comprising first and second calculation blocks for generating first and second current state metrics respectively from first and second previous state metrics and first and second associated branch metrics and from third and fourth previous state metrics and third and fourth associated branch metrics;
a third calculation block of claim 1 receiving as an input the first and second current state metrics; and
an adder for generating a third current state metric equal to the sum of the outputs of the third calculation block wherein the previous state metrics are each coded over a same number of bits, said adder performing additions without keeping the carry so that the third current state metric comprises the same number of bits as the previous state metrics.

3. The device of claim 1, wherein the calculation block comprises:
a subtractor for calculating the difference between the first and second values received by the calculation block;
a multiplexer controlled by the output of the subtractor to generate on the first output of the calculation block the largest of the received values;
an approximation block for generating on the second output of the calculation block the adjustment value in the form of a value of one bit equal to 1 if said difference is equal to 0, 1, or −1, and equal to 0 otherwise.

4. The device of claim 3, wherein the approximation block comprises a first logic gate calculating a NOR of all the bits of said difference except for its least significant bit, a second logic gate calculating an AND of all the bits of said difference, and a third logic gate calculating an OR of the outputs of the first and second logic gates.

5. A decoder comprising 2^{N}, where N is greater than 1, devices of claim 2, each of which is associated with a specific N bit value, the decoder receiving data in the form of consecutive bibits;
the output of each device associated with a first value being connected to provide one of the previous state metrics to four devices, each associated with a value, the N−2 most significant bits of which are the N−2 least significant bits of said first value and the two least significant bits of which respectively are one of the four possible values of the last received bibit;
each device associated with a first value, the two least significant bits of which are one of the four possible values of a bibit, receiving as branch metrics a value corresponding to a distance between the received bibit and said one of the four possible values of a bibit.

6. A method for implementing a function of add-compare-select-offset type in an error-correction code decoder operating in monobinary mode, comprising the steps of:
i/ generating first and second intermediary metrics values, a and b, respectively equal to the sum of a first previous state metric and of an associated branch metric and to the sum of a second previous state metric and of an associated branch metric;
ii/ comparing values a and b, selecting the largest of values a and b, and providing said selected value on a first output, and generating on a second output an adjustment value corresponding to an approximation of ln(1+e^{-|a-b|}); and
iii/ generating a current state metric equal to the sum of the outputs of the calculation block;
the first and second previous state metrics being coded over a same number of bits and the sums calculated at steps i/ and iii/ being performed without keeping the carry, so that the current state metric and intermediary values a and b comprise the same number of bits as the first and second previous state metrics.

7. A method for implementing a function of add-compare-select-offset type in an error-correction code decoder operating in duobinary mode, comprising the steps of:
iv/ generating first and second current state metrics according to the method of claim 6, respectively from first and second previous state metrics and from first and second associated branch metrics and from third and fourth previous state metric and from third and fourth associated branch metric;
v/ providing a selected value and an approximation value calculated according to step ii/ of claim 6, based on the first and second current state metric; and
vi/ generating a third current state metric equal to the sum of the values generated at step v/, the previous state metric being each coded over a same number of bits and said sum being calculated without keeping the carry so that the third current state metric comprises the same number of bits as the previous state metrics.

8. The method of claim 6 or 7, wherein at step ii/, the value is selected by calculating the difference of the compared values and by providing the largest of the compared values based on the sign of said difference, and wherein the adjustment value is generated as being a value of one bit equal to 1 if said difference is equal to 0, 1, or −1, and equal to 0 otherwise.

9. The device of claim 8, wherein the adjustment value is equal to the logic OR of a logic NOR of all the bits of said difference except for its least significant bit and of a logic AND of all the bits of said difference.

10. A decoding in a lattice comprising 2^{N}, where N is greater than 1, states, each associated with a specific N-bit value, of data received in the form of consecutive bibits, comprising the steps of:
vii/ for the first received bibit, generating according to the method of claim 7 2^{N} current state metrics each associated with one of said values based on four predetermined initial previous state metrics and based on four identical branch metrics corresponding to a distance between the received bibit and a value of the bibit equal to the two least significant bits of said one of said values;
viii/ for each subsequently received bibit, generating according the method of claim 7 2^{N} current state metrics each associated with one of said values, taking for the four previous state metrics the four current state metrics generated for the previous received bibit and associated with a value, the N−2 least significant bits of which are the N−2 most significant bits of said one of said values, and taking for the four branch metrics a distance between the received bibit and a value of the bibit equal to the two least significant bits of said one of said values.
